(19) United States
(12) Patent Application Publication
(10) Pub. No.: US 2011/0132180 A1
(43) Pub. Date: Jun. 9, 2011

(54) LASER PICKUP

(76) Inventor: Uli Gobbers, Viersen (DE)

(21) Appl. No.: 13/058,157

(22) PCT Filed: Jun. 16, 2009
(86) PCT No.: PCT/EP2009/004355

§ 371 Date: Feb. 24, 2011

(30) Foreign Application Priority Data
Aug. 29, 2008 (DE) 10 2008 044 933.4

(51) Int. Cl. G10H 1/14

(52) U.S. Cl. 84/622

(57) ABSTRACT

The invention relates to a method for determining the pitch of a vibrating string (1) of a string instrument as well as a string instrument comprising at least one such string (1) that is mounted between a bridge (2) and a nut (3). The string (1) can be fixed to a specific attachment point between the bridge (2) and the nut (3) by means of a member (4) in order to generate a sound that is higher than the basic pitch. The distance (D) between the bridge (2) and the attachment point is determined by means of an optical measuring device (6, 7), and the pitch of the vibrating string (1) is then determined from the distance (D).

The present invention relates to a method for determining the pitch of a vibrating string of a stringed instrument stretched between a bridge and a nut, the string being fixable at a given fixing point between the bridge and the nut, using a member, in order to generate a tone having a higher pitch than a fundamental tone. The invention further relates to a corresponding stringed instrument having at least one vibrating string stretched between a bridge and a nut, the string being fixable at a given fixing point between the bridge and the nut, using a member, in order to generate a tone having a higher pitch than a fundamental tone, for which the method according to the invention may be used.

In modern pop and rock music it is very common to use musical instruments not to directly produce a tone or sound, but instead to merely generate, or analyze and convert, electrical signals which are further processed by a computer or other circuits. Standardized interfaces exist for this purpose, the MIDI interface being the most commonly used.

Whereas such signal generation or analysis is relatively easy for keyboard musical instruments because exactly one pitch is associated with a key, and the loudness may be determined via the striking speed of the key, signal analysis for stringed instruments, for example guitars, is very difficult. In such stringed instruments a fundamental tone is assigned to each string. However, the pitch of a plucked, struck, or otherwise excited string may be varied, i.e., raised by shortening the vibration length of the string, by pressing the string at certain bars or frets by a member, in particular a finger. Thus, in order to determine the correct pitch, first the formation of such a tone must be awaited, and then the frequency or duration of at least one, but preferably multiple, periods must be measured in order to find the pitch with the necessary degree of reliability.

U.S. Pat. No. 4,823,667 discloses a signal analysis device in the form of an electronic musical instrument activated in the manner of a guitar, wherein a frequency analyzer is provided which determines the frequency of the excited string. However, such a procedure results in timing problems. In a standard guitar, the lowest tone has a frequency of 82 Hz, so that a full vibration requires approximately 12.5 ms. For reliability reasons it is usually necessary to measure two vibrations in order to obtain reliable information, so that the required time adds up to 25 ms. Consideration is not made for the fact that after the excitation, for example by plucking or striking, the string requires a certain amount of time to reach the steady state. As a rule, this likewise requires an additional, not insubstantial, period of time which may be twice the length of a period, so that the desired pitch information is available only after 50 ms. However, a time delay of 50 ms is clearly noticeable to a musician. This corresponds to setting up a speaker box at a distance of approximately 15 m.

EP 0734567 [U.S. Pat. No. 5,824,937] describes a method by means of which the pitch may be determined much more quickly, in that instead of wave form analysis, the first pulse groups and their propagation times along the string are evaluated. The latency is greatly reduced in this manner. However, the method is very sensitive to interfering pulses, thus requiring precise adjustment to the instrumentalists and the instrument. In addition, a very exact and clean playing style is required, which every guitarist does not have.

An alternative solution to this problem is disclosed in U.S. Pat. No. 5,085,119. Switches are provided on the guitar neck which are activated when the appropriate string is pressed at the desired fret. However, the pitch information, the same as for a keyboard instrument, is obtained not by the string vibration, but by depressing a switch. This makes playing much more difficult.

EP 0 227 906 [U.S. Pat. No. 4,723,968] discloses an electronic stringed instrument in the manner of a guitar, having an evaluation device for determining the pitch produced by the guitar strings during play. The evaluation device is connected to two pickups. One pickup is used for determining the vibration of the string itself. A tone is emitted as long as the string vibrates. The other pickup at the same time has the function of a transmitter which sends ultrasonic pulses to the string. The propagation time of the ultrasonic pulses may be evaluated to obtain information concerning the string length, and thus, the pitch.

EP 0 288 062 [U.S. Pat. No. 4,873,904] discloses a similar musical instrument, having a signal analysis device in which the pickup apparatus likewise has an acoustic pickup which determines the vibration of the string itself, and an ultrasonic apparatus which supplies ultrasonic pulses to the string. The ultrasonic pulses are reflected on the frets and received by the pickups. The time difference between the transmission and the reception of the ultrasonic pulses provides information concerning the active string length. Acoustic pickups of this type are expensive, and their manufacture is complicated. The signal analysis must be performed with a high degree of quality in order to extract the pitch from the acoustic waves emitted by the string, using deep pass filtering, the waves forming a superimposition of the fundamental and harmonic components of the string and the supplied ultrasonic pulses. To allow the detection of the ultrasonic pulses to be filtered from the measured signal of the pickup, in the digitization of the signal for the further signal processing it is necessary to use high-frequency scanning of the measured signal. Lastly, the measuring method using ultrasonic pulses is unreliable and imprecise, since the pulses are greatly damped upon reflection on the frets, and arrive in attenuated form at the pickup. Thus, extraction of the pulses from the measured signal is possible only using complicated technical means.

An electric guitar synthesizer is known from European Patent application EP 1 280 134 A1, in which optical sensors are used which detect the start and end of a note which may be produced by striking the string. An optical sensor is situated at one end of each string, and at the other respective end, an optical detector. In this guitar synthesizer, the pitch of the struck string is determined using an electrical measuring method. The fret bars which divide the fingerboard into individual frets are connected to one another via a resistor chain, the fret bars on the outside being connected to a voltage source. When a string is pressed onto the fingerboard, the string is electrically connected to one of the fret bars, so that a corresponding voltage at the string defined by the resistor chain may be tapped, measured, and used for determining the corresponding pitch. A disadvantage of this method is that the fingerboard must be supplied with power, which entails considerable technical complexity and results in significant ohmic losses due to the resistance bridge.

In addition, an optical measuring method for determining the vibration of a string is known from U.S. Pat. No. 5,214,232. A system composed of an optical transmitter and an adjacently situated optical detector is used that is mounted beneath a string on the body of the stringed instrument. A light-emitting element transmits light in the direction of the string, which reflects the light and transmits it back in the direction of the body, and the reflected light is received by the optical detector. Sound generation means generate the corresponding tone of the string via the photocurrent of the detector. This system implements a classical pickup using an optical design.

Furthermore, a method is known from U.S. Pat. No. 4,321,463 for optical determination of the pitch of a vibrating string of a stringed instrument. The strings of the instrument are each formed by glass fiber bundles through which light of a coherent laser is transmitted. A detector detects the light exiting at the other end of the glass fibers with respect to an interference pattern. This interference pattern is modulated via a mechanical vibration of the string, the modulation being expressed as the electrical signal of the detector. The modulated electrical detector signal is made audible by use of a conventional amplifier.

All of the above-mentioned methods are comparatively complex in their technical implementation, and involve high design costs for the stringed instrument.

The object of the invention, therefore, is a technically simple method for determining the pitch of an excited string of a stringed instrument, and a corresponding stringed instrument in which the pitch is rapidly and reliably determined with high accuracy, with low costs for the technical implementation of the method.

This object is achieved by the features of independent claims 1 and 9. Advantageous refinements are stated in the respective subclaims, and may also be inferred from the following general description of the important aspects of the invention.

According to the invention, it is provided that in the method for determining the pitch of a vibrating string of a stringed instrument stretched between a bridge and a nut, the string being fixable at a given fixing point between the bridge and the nut, using a member, in order to generate a tone having a higher pitch than a fundamental tone, the distance between the bridge and the fixing point is determined using an optical measuring device, and the pitch of the vibrating string is determined based on the distance.

The optical measurement of the distance provides accurate, rapid results. Delays up to the time of pitch determination, resulting from the measurement of one or more oscillation periods or from the propagation time of acoustic ultrasonic pulses on the string, may be reduced to a minimum due to the fact that optical distance measurement methods operate using light beams which, as is known, travel at the speed of light.

The fixing point is generally formed by placing a finger on the string, the finger being supported against a neck of the stringed instrument, the string extending on the front side. Alternatively, another object such as a capo, for example, may be used for fixing the string. As a result of the fixing, the length of the vibrating portion of the string that is excited for the tone generation is reduced, so that a tone is generated that is higher in pitch than the fundamental tone of the string.

In one advantageous refinement of the invention, a modulated light beam of a modulated laser light source may be emitted in a beam direction extending parallel to the string. The light beam is then reflected on the nut or the member which may be introduced in the beam direction, in particular a finger. The reflected light beam is then received by at least one light-sensitive detector, it being possible to determine the distance based on the propagation time of the light beam between its emission and the reception of the reflected light beam. Due to the high coherence of the light beam, use of a laser light source ensures secure and reliable distance measurement. The light beam may pass at a distance of a few millimeters, in particular in the range of 1 to 3 mm, from the string, thus ensuring that the light beam is able to strike the member. As the result of modulating the light beam, a given periodically occurring event in the light beam that is characteristic for the modulation may be used as a measure of time, thus allowing the propagation time, i.e., the time period between the generation and the reception of the characteristic event, to be detected.

The modulation of the light beam may have different forms. The emitted beam may preferably be modulated using a square-wave signal. As a result, light pulses of a specific duration are emitted. The square-wave modulation may be carried out, for example, by pulsed irradiation by the laser light source, by mechanical means such as a shutter, or by optical means. The light pulses are then emitted parallel to the string, reflected on the nut or the member which may be introduced in the beam direction, and received by the detector. Since the speed of light is known, the distance may be determined from the time difference between the emission of a pulse and its reception. If the laser light source and the detector are adjacently situated on the bridge, for simplification it may be assumed that the run length of the laser light beam is twice this distance. The distance D may then be determined from the formula D≈0.5*2.99*10 exp (8)*t, where t is the measured propagation time of the light beam, i.e., light pulse. The distance may be calculated with greater accuracy by including the distance between the laser source and the detector in the calculation. This may be carried out as described below. The path length W traversed by the laser beam is the sum of hypotenuse c and leg D in a right triangle, where D corresponds to the distance to be determined: W=c+D. Leg b is the distance between the laser source and the detector. Since the square of the hypotenuse is equal to the sum of the squares of the two legs, it follows that the path length W is the square root of (D exp (2)+b exp (2))+D. The following expression may then be derived: D=(W exp (2)−b exp (2))/(2W).

In stringed instruments, sound is generally produced by strumming, plucking, or striking the string with an object, for example the fingers, a plectrum, or a bow, in the region of the lower one-third of the string. The object may possibly pass into the beam path, resulting in reflection of the light beam or the light pulse on the object. This would result in an incorrect pitch determination. According to the invention, it may therefore be provided that the pitch is determined only when the ascertained distance is greater than approximately one-third the distance between the bridge and the nut. If an object in this region then passes into the beam path of the laser light source, a detector signal received due to the reflection of the light beam or pulse on this object may be filtered out, so that this signal is not used for the pitch determination.

According to the invention, the pitch may be determined in such a way that a specific pitch is associated with a determined distance. The association may be made, for example, on the basis of a stored table or by calculation.

For stringed instruments which have frets, the pitch may be determined in such a way that a specific corresponding distance range between two frets is first associated with a determined distance, and a specific pitch is then associated with this distance range. The distance range is the distance between two frets. Because the vibrating portion of the string is delimited from above by a fret, a finger placed at any position within the distance range, behind this fret and in front of the next fret, for fixing the string thereon results in the same vibrating length of the string, i.e., the same tone.

In another advantageous embodiment of the invention, a tensile force acting on the string may be measured using a pressure sensor, and the given pitch is upwardly corrected by a numerical value as a function of the measured tensile force. This allows recognition of a raised pitch of the string, which a musician may produce by so-called pitch bending, i.e., pulling the string to the side.

For guitars and other stringed instruments having two or more strings, light pulses may be emitted in succession parallel to each string. This is preferably carried out in a consecutive manner so that the reflected light pulses which are received by the detector(s) may be associated with a specific light source, i.e., a specific string. The transmission of the light pulses in succession may be carried out, for example, by multiplexing the laser diodes or supplying same with power.

For carrying out the method according to the invention, a stringed instrument is proposed which has at least one vibrating string stretched between a bridge and a nut, the string being fixable at a given fixing point between the bridge and the nut, using a member, in order to generate a tone having a higher pitch than a fundamental tone, and the stringed instrument having an optical measuring device for determining the distance between the bridge and the fixing point, and an evaluation unit for determining the pitch based on this distance.

The optical measuring device may include a laser light source for emitting a modulated light beam in a beam direction extending parallel to the string. The optical measuring device may also include at least one light-sensitive detector for receiving a light beam reflected on the nut or the member which may be introduced in the beam direction. The measuring device may also be set up for determining the distance between the bridge and the fixing point, based on the propagation time of the light beam between its emission and the reception of the reflected light beam.

In one advantageous refinement, the laser light source may be a pulsed laser diode for emitting light pulses parallel to the string. Pulsing of the laser light source generates a square-wave modulated light beam formed by individual light pulses.

The laser light source may preferably be situated on the bridge next to the string. The orientation may in particular be to the right or the left, preferably at a distance of approximately 1 to 3 mm. This ensures that a member used for fixing the string, in particular a finger, is detected by the light beam or the light pulse, thus allowing a distance determination, i.e., a pitch determination. The laser light source may be situated on the bridge in particular in such a way that the light beam or the light pulse is emitted at the same level as the beginning of the vibrating portion of the string. The detector may also be situated on the bridge next to the string. This allows a particularly simple calculation of the distance, since the distance then corresponds to twice the run length of the light, disregarding the distance between the laser source and the receiver. In one alternative embodiment variant, however, the laser light source may also be set back from the bridge by a given distance. This is then correspondingly taken into account for the distance determination by subtracting this distance from the run length of the light.

A laser light source having the wavelength in the nonvisible range, preferably in the infrared range, for example, may be selected as the laser light source. In this manner the musician is not distracted from playing. However, by using colored light beams in the visible range, special light effects may be produced which are particularly impressive on stage. Therefore, as an alternative the laser light source may preferably also have a wavelength in the visible light range.

The string is generally clamped in a string holder behind the bridge. In one advantageous refinement of the invention, a pressure sensor for detecting the tensile force acting on the string may be associated with the string, the pressure sensor being mechanically connected to the string holder. The detection of the tensile force allows recognition of an increase in tensile force, which the musician is able to achieve by pulling the string to the side as a musical effect which causes a specific increase in pitch.

For a stringed instrument having two or more strings, it may be provided according to the invention that a laser light source for emitting light pulses parallel to the corresponding string is associated with each string on the bridge. In addition, a light-sensitive detector may be situated on the bridge next to each string.

Further features and advantages of the invention may be obtained from the following description of exemplary embodiments and from the figures, which show the following:

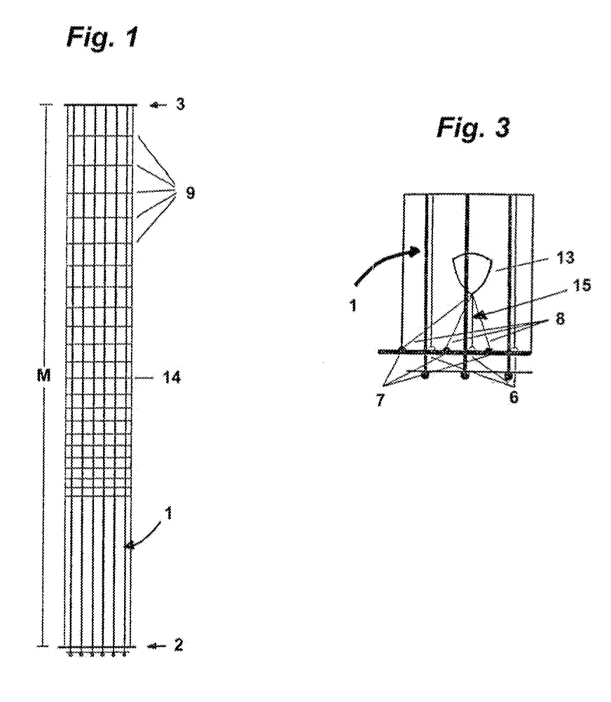

FIG. 1: shows an illustration of a guitar fingerboard

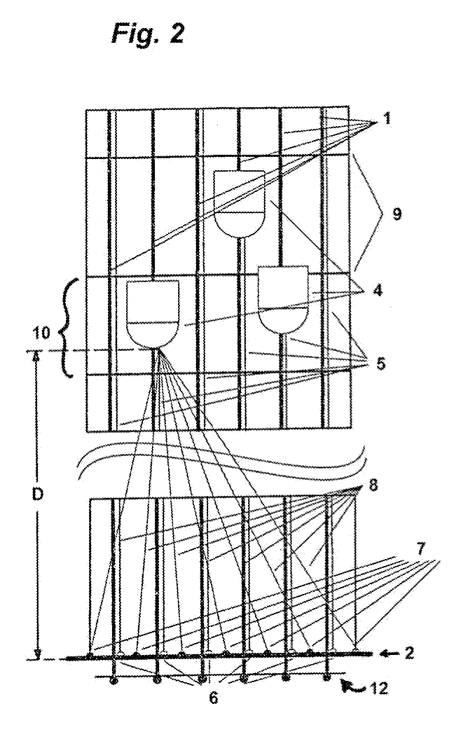

FIG. 2: shows an illustration of the optical measuring device in operation, by way of example

FIG. 3: shows a detail of the string configuration of a guitar having an optical measuring device for recognizing the plucking position of the string

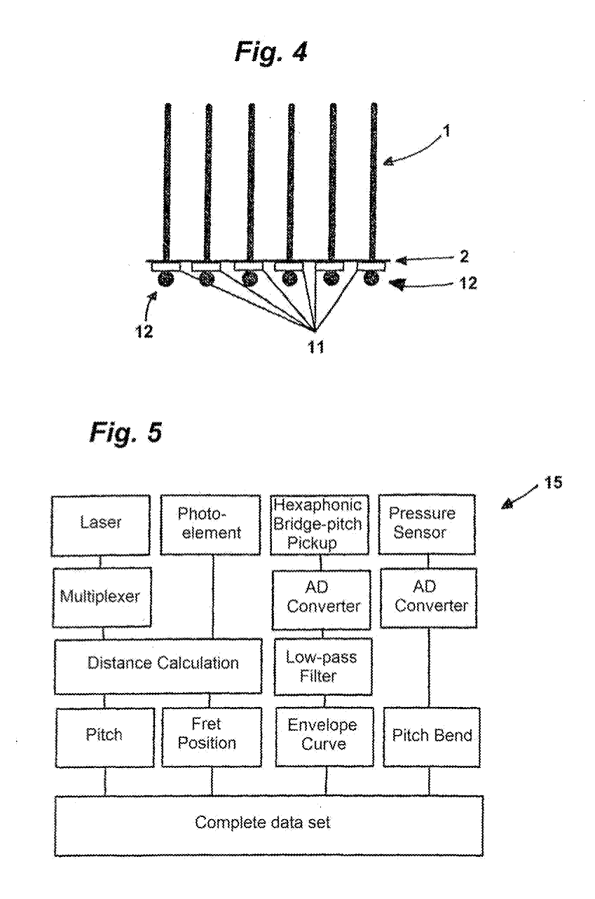

FIG. 4: shows a schematic illustration of a string tension measuring unit

FIG. 5: shows the design of a sensor and processor unit.

The aspects important to the invention are explained below, using an electric guitar as an example of a stringed instrument.

The guitar has a signal analysis device together with at least one stretched string, whose vibratable length may be changed by pressing at least one fret, and has a pickup, an optical measuring device for measuring the length of the active string, and an evaluation device connected to the pickup.

The invention is based on the physical fact that the frequency of a vibrating string is linearly proportional to the reciprocal of the string length. When a string of length L vibrates at the frequency f, one-half the string length results in twice the frequency, one-third the string length results in three times the frequency, one-fourth the string length results in four times the frequency, and so forth.

FIG. 1 shows a fingerboard of a guitar, which has a bridge 2 and a nut 3, between which six strings 1 are stretched. The fingerboard is divided into frets 9. The overall length of each string 1 corresponds to the distance M from the nut 3 to the bridge 2, referred to as the scale length. The strings have different fundamental tones; i.e., they vibrate at different frequencies. Reducing the vibrating string length by half results in a doubling of the frequency. The one-half point is at the twelfth fret 14. The vibrating portion of the string 1 between this fret 14 and the bridge 2, as well as the vibrating portion of the string between the fret 14 and the nut 3, generates a tone one octave above the fundamental tone.

In order to produce a pitch higher than the fundamental tone, the string 1 may be fixed at a specified fixing point between the bridge 2 and the nut 3, using a member 4. For this purpose the musician generally uses a finger 4. The finger is pressed onto the fingerboard, thus shortening the vibrating portion of the string 1. This changes the frequency as desired by the musician. When the length of the vibrating string 1 from the bridge 2 to the finger 4 is measured, and when the fundamental tone of the vibrating string is known, based on these values the frequency, and therefore the tone, which sounds as soon as the string 1 is excited to vibration may be definitively determined. Since the fundamental tones of the strings 1 are known for a guitar, precise tuning of the string 1 is no longer necessary. The complicated and time-consuming tuning of the strings 1 may therefore be dispensed with.

Thus, in this manner the pitch may be identified before the string 1 sounds, which eliminates the problem of latency in the analysis of the vibrating string.

Mathematical principles:

a=b/(1/c),

where a is the difference in the scale length in order to raise the pitch by a half tone, b is the scale length of the fundamental tone, and c is the reciprocal of the fret constant. Since c is the factor which allows calculation of the difference in the two scale lengths for the two tones at a half-tone interval, a simple formula applies. This formula is used to determine the value, so that after 12 subtractions (which are always the same in relation to the remaining scale length) exactly one-half the scale length is obtained (one-half scale length=one octave=half the frequency). ½=(1−c) exp (12), where c stands for the constant 0.056125687. From this value the fret constant may be directly derived, which is the reciprocal of c: 1/c corresponds to approximately 17.81715. Further fret positions may be derived from the calculated scale length by equating variable b to the remaining scale length, and thus calculating the distance from the first fret to the second fret. Thus, the only further requirement is to use the well-known methods for envelope curve determination in the signal analysis in order to also add the volume progression (striking force, tone duration, etc.) after excitation of the string to the string frequency as parameters for the pitch. Commercially available hexaphonic magnetic or piezoelectric pickups may be used for this purpose.

FIG. 2 shows a simplified illustration of the optical measuring method for a six-string guitar for determining the pitch of the vibrating portions of the strings 1. The optical measuring device has six laser light sources 6, one laser light source 6 for emitting light pulses 5 in a beam direction extending parallel to the respective string 1 [being associated with] each string 1. The beam direction runs approximately 1 mm to the right of a particular string 1. The laser diodes 6 are situated on the bridge 2. The second, fourth, and fifth string 1 from the left are each pressed against the neck of the guitar by a respective finger 4. The fingers 4 therefore pass into the beam path of the light pulses 5. For the second string 1 from the left, it is illustrated by way of example that reflections 8 thus result on the corresponding finger 4 which extend in a fan-shaped manner toward the bridge 2 and which are received by photoelements 7, designed as phototransistors, for example, which are situated on the bridge between the strings. Based on the run length of the pulses 5, which corresponds to twice the distance D between the fixing point formed by the finger 4 [and] the bridge 2, under the simplifying assumption that the detector 7 is situated near the laser light source 6, the distance D may be determined from D≈0.5*2.99*10 exp (8)*t, where t is the measured propagation time of the light pulse 5. When a distance b between the laser light source is taken into account, the site of the laser light source 6, the site of the finger 4, and the site of the detector 7 form a right triangle. The path length W traversed by the laser beam is the sum of the hypotenuse c and the leg D; i.e., the distance to be determined is W=c+D. The distance between the laser source 6 and the detector 7 is leg b. Because the square of the hypotenuse corresponds to the sum of the squares of the two legs, it follows that W=square root of (D exp (2)+b exp (2))+D. The following expression may then be derived: D=(W exp (2)−b exp (2))/(2W).

Based on the distance D, first a given distance range 10 may be determined in which the finger 4 is positioned, and that is situated between two frets 9 whose distance from the bridge is known. In FIG. 2 these are the second and third frets 9 from the top. Since the string 1 lies on the third fret 9, this fret delimits the vibrating portion of the string 1. The pitch may then be determined by an association with a distance D, which may be stored in a table.

Shown below by way of example is an association table for the first string from the left, which has a fundamental tone of E. The relationship between the string length and the pitch, assuming an equal temperament, and for a scale length M assuming a distance of 65 cm from the bridge 2 to the nut 3, is as follows:

| Distance No. | Distance, cm (ex.) | Tone (ex.) |
|---|---|---|
| 0 (open string) | 65 | E |
| 1 | 61.3518 | F |
| 2 | 57.9084 | F# |
| 3 | 54.6583 | G |
| 4 | 51.5906 | G# |
| 5 | 48.6947 | A |
| 6 | 45.9617 | A# |
| 7 | 43.3821 | H |
| 8 | 40.9473 | c |
| 9 | 38.6491 | c# |
| 10 | 36.4799 | d |
| 11 | 34.4324 | d# |
| 12 | 32.5 (½ scale length) | e (octave) |
| 13 | 30.6759 | f |
| 14 | 28.9542 | f# |
| 15 | 27.3291 | g |
| 16 | 25.7952 | g# |
| 17 | 24.3475 | a |
| 18 | 22.9810 | a# |
| 19 | 21.6912 | h |
| 20 | 20.4738 | c′ |
| 21 | 19.3247 | c# |
| 22 | 18.2401 | d′ |

In summary, the invention is described as follows:

The invention comprises a set of laser diodes 6 which are mounted on the bridge 2 of the particular instrument. According to the invention, a laser diode 6 is associated with each string 1, i.e., six strings for a standard guitar, four strings for a standard bass 4, likewise four strings for a customary stringed instrument, and so forth. Six diodes 6 are likewise sufficient for a 12-string guitar, since in this case two strings are always changed in pitch by one respective finger 4. These diodes 6 are placed close to the pickup point of the string 1, and the laser light 5 is emitted parallel to the string in the direction of the nut 3. The laser light 5 has a high degree of parallelism, i.e., coherence, so that the smallest possible reflection point may result. Placed in the same plane as the laser diodes 6 are one or more light-sensitive components 7 such as phototransistors or photodiodes, for example, which pick up the reflected light 8. The position of the finger 4 on the string 1 may be determined from the propagation time of the laser light 5.

The six laser diodes 6 are multiplexed, since otherwise their emitted light from the detectors 7 could not be associated with the respective string 1, i.e., light emission source 6. It is practical for the reflected light 8 to be received by multiple photoelements 7, and for the resulting data to be evaluated by a processor unit. The signals from individual pickups for each string, for example from a hexaphonic piezoelectric pickup, are used for evaluating the time of striking, the striking speed, and the period of time that the string 1 sounds. In addition, by using a suitable, known form of signal analysis the fundamental component of the individual strings, and thus the tuning of the instrument, may be easily checked. It may be meaningful to use this analysis for correcting the frequencies determined by the laser measurement in order to compensate for and readjust design-related differences of various instruments or characteristics specific to the method of playing. In addition, this check may be used to determine a positioning offset which must be taken into account as the result of retrofitting with a laser pickup, i.e., a system of laser light sources 6 and detectors 7, which is placed in front of the bridge.

In addition to the pitch information, the position of the plucking finger or of the plectrum 13 may be determined, since the finger or plectrum likewise reflects the laser beam 5 for a brief time, and the detectors 7 receive the reflected laser light 8. This is illustrated in FIG. 3. Since the string 1 is plucked or struck in the region of the first one-third of the string in front of the bridge 2, the ascertained distance D may be used to determine whether the reflections 8 originate from a finger 4 for fixing the string 1 or from a plucking or striking finger or plectrum 13. In this case, no pitch is assigned to the determined distance D.

A playing technique typical for the guitar, such as bending, i.e., pulling the strings, may be detected by an interplay of the described techniques and by using an additional measuring sensor 11, in particular a pressure sensor, for the string tension. Such an embodiment variant is illustrated in FIG. 4. A pressure sensor 11 may be associated with each string holder 12 in which a string 1 is clamped, the pressure sensor being mechanically connected to the string holder to allow detection of the tensile force acting on the string 1.

A piezocrystal may be installed in the string holder 12 of the bridge 2 as the measuring sensor 11. The change in frequency of a vibrating string 1 is proportional to the change in the tensile force according to the formula k=M/L*(f*2L) exp (2), where k=force, M=mass, L=length, and f=frequency. Since the values of M and L may be assumed to be constant for simplification, this results in an exponential relationship between the frequency and the tensile force. The frequency f is proportional to the square root of k. Thus, the pitch information for a pulled string 1 may likewise be definitively ascertained by determining the vibrating string length and the subsequent change in tensile force on this string.

FIG. 5 shows a schematic illustration, by way of example, of the design of a sensor and processor unit 15, which a stringed instrument according to the invention may have. This sensor and processor unit includes the optical measuring unit composed of a set of laser diodes 6, a multiplexer for alternatingly supplying the laser diodes 6 with power, photoelements 7, and a distance calculation unit. The sensor and processor unit also includes an evaluation unit set up to associate the corresponding pitch with the determined distance D, and to determine the striking position in the event that an association cannot be made due to the fact that the determined distance D is less than one-third of the length of the string 1. The sensor and processor unit 15 may also have a customary hexaphonic bridge pickup whose measured analog signal is digitized using an AD converter, then filtered in a deep pass filter, followed by determination of the envelope curve. According to the invention, the sensor and processor unit 15 may also include the pressure sensors 7, whose measured analog signal may likewise be digitized using an AD converter, and from which an increase in pitch, i.e., a so-called pitch bend, may be determined. From the totality of the three information sources, i.e., the laser distance measurement using the detectors 7 for determining the pitch, the customary hexaphonic pickups for determining the striking time and the envelope curve, and the pressure sensors 11 for determining the deviation of the pitch from the fundamental tone as the result of a pitch bend, a complete data set is defined for which the tone generated by the string 1 is sufficiently described, and for electronic processing, is completely described.

1. A method for determining the pitch of a vibrating string of a stringed instrument stretched between a bridge and a nut, the string being fixable at a given fixing point between the bridge and the nut, using a member, in order to generate a tone having a higher pitch than a fundamental tone, wherein the distance between the bridge and the fixing point is determined using an optical measuring device, and the pitch of the vibrating string is then determined based on the distance.

2. The method according to claim 1, wherein a modulated light beam of a laser light source is emitted in a beam direction extending parallel to the string, the light beam being reflected on the nut or the member which may be introduced in the beam direction, and is received by at least one light-sensitive detector, and the distance is determined based on the propagation time of the light beam between its emission and the reception of the reflected light beam.

3. The method according to claim 2, wherein the laser light source is pulsed, wherein light pulses are emitted parallel to the string, reflected on the nut or the member which may be introduced in the beam direction, and received by the detector.

4. The method according to claim 1, wherein the pitch is determined only when the ascertained distance is greater than approximately one-third the distance between the bridge and the nut.

5. The method according to claim 1, wherein the pitch is determined in such a way that a specific pitch is associated with a determined distance.

6. The method according to claim 1, wherein the pitch is determined in such a way that a specific corresponding distance range between two frets of the stringed instrument is first associated with a determined distance, and a specific pitch is then associated with this distance range.

7. The method according to claim 1, wherein a tensile force acting on the string is measured using a pressure sensor, and the given pitch is upwardly corrected by a numerical value as a function of the measured tensile force.

8. The method according to claim 1 for determining the pitch of vibrating string of a stringed instrument having two or more strings, wherein light pulses are emitted in succession parallel to each string.

9. In a stringed instrument having at least one vibrating string stretched between a bridge and a nut, the string being fixable at a given fixing point between the bridge and the nut using a member in order to generate a tone having a higher pitch than a fundamental tone,
an optical measuring device for determining the distance between the bridge and the fixing point, and
an evaluation unit for determining the pitch based on this distance.

10. The stringed instrument according to claim 9, wherein the optical measuring device includes a laser light source for emitting a modulated light beam in a beam direction extending parallel to the string, and at least one light-sensitive detector for receiving a light beam reflected on the nut or the member which may be introduced in the beam direction, the measuring device being set up for determining the distance between the bridge and the fixing point based on the propagation time of the light beam between its emission and the reception of the reflected light beam.

11. The stringed instrument according to claim 10, wherein the laser light source is a pulsed laser diode for emitting light pulses parallel to the string.

12. The stringed instrument according to claim 10, wherein the laser light source is situated on the bridge next to the string.

13. The stringed instrument according to claim 10, wherein the detector is situated on the bridge next to the string.

14. The stringed instrument according to claim 9, wherein the string is clamped in a string holder behind the bridge, wherein a pressure sensor for detecting the tensile force acting on the string is associated with the string, and is mechanically connected to the string holder.

15. The stringed instrument according to claim 9, having two or more strings, wherein a laser light source for emitting light pulses parallel to the corresponding string is associated with each string on the bridge.
